(19) United States
(12) Patent Application Publication
(10) Pub. No.: US 2025/0065814 A1
(43) Pub. Date: Feb. 27, 2025

(54) CARRYING RACK AUXILIARY DEVICE AND CARRYING RACK INCLUDING THE SAME

(71) Applicant: YOTTA INNOVATION CO., LTD., APIA (WS)

(72) Inventor: STELLA HUANG, Taipei City (TW)

(21) Appl. No.: 18/453,094

(22) Filed: Aug. 21, 2023

(51) Int. Cl. B60R 9/10; B60R 9/06; B65G 69/30

(52) U.S. Cl. CPC B60R 9/10; B60R 9/06; B65G 69/30

(57) ABSTRACT

A carrying rack auxiliary device and a carrying rack including the same are provided. The carrying rack auxiliary device is configured to be mounted to at least one wheel restricting ring. The at least one wheel restricting ring defines a longitudinal central axis. The auxiliary device includes: a guide board; and an attachment member connected to an end of the guide board and including a plurality of saddle portions separate from each other, the plurality of saddle portions being configured to be saddled on the at least one wheel restricting ring frame so that the plurality of saddle portions are entirely located out of the longitudinal central axis and so that the guide board is inclined relative to the longitudinal central axis.

### BACKGROUND OF THE INVENTION

### Field of the Invention

The present invention relates to a carrying rack auxiliary device and a carrying rack including the same.

### Description of the Prior Art

A carrying rack can be used to carry at least one vehicle such as a bicycle, electric bicycle and electric scooter. In use, the user has to move and push the vehicle to load on or unload from the carrying rack. For transporting a vehicle having a heavy weight, some carrying racks can be used with an auxiliary guiding board that spans between the ground and the carrying rack, and then the vehicle can be pushed onto the carrying rack along the auxiliary guiding board, which is labor-saving.

However, the conventional auxiliary guiding board is mounted on the carrying rack with an end located at a point where the wheel will contact and the end of the auxiliary guiding board will be pressed and urged by the wheel, so the conventional auxiliary guiding board cannot be or is difficultly removed from the carrying rack, which is extremely inconvenient to use.

The present invention is, therefore, arisen to obviate or at least mitigate the above-mentioned disadvantages.

### SUMMARY OF THE INVENTION

The main object of the present invention is to provide a carrying rack auxiliary device and a carrying rack including the same which can labor-savingly, quickly and stably guide a vehicle to the carrying rack.

To achieve the above and other objects, a carrying rack auxiliary device configured to be mounted to at least one wheel restricting ring defining a longitudinal central axis is provided, wherein the carrying rack auxiliary device includes: a guide board; and an attachment member connected to an end of the guide board and including a plurality of saddle portions separate from each other, the plurality of saddle portions being configured to be saddled on the at least one wheel restricting ring frame so that the plurality of saddle portions are entirely located out of the longitudinal central axis and so that the guide board is inclined relative to the longitudinal central axis.

To achieve the above and other objects, a carrying rack including the carrying rack auxiliary device is provided, wherein the carrying rack further includes: a base frame configured to be connected to a vehicle; and the at least one wheel restricting ring.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a carrying rack and a carrying rack auxiliary device according to an exemplary embodiment of the present invention;

FIG. 2 is a partial breakdown drawing of FIG. 1;

FIG. 3 is a breakdown drawing of the carrying rack auxiliary device of an exemplary embodiment of the present invention;

FIG. 4 is a partial enlargement of FIG. 3;

FIG. 5 is a partial enlarged cross-sectional view of the carrying rack auxiliary device of an exemplary embodiment of the present invention;

FIGS. 6 and 7 are drawings showing application of the carrying rack and the carrying rack auxiliary device according to an exemplary embodiment of the present invention; and

FIG. 8 is a partial enlarged cross-sectional view of another carrying rack auxiliary device of an exemplary embodiment of the present invention.

### DETAILED DESCRIPTION OF THE PREFERRED EMBODIMENTS

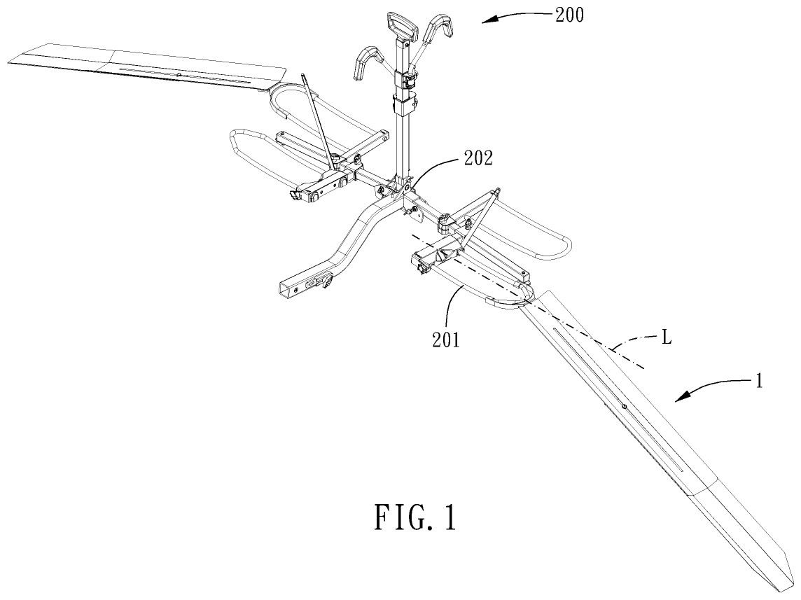

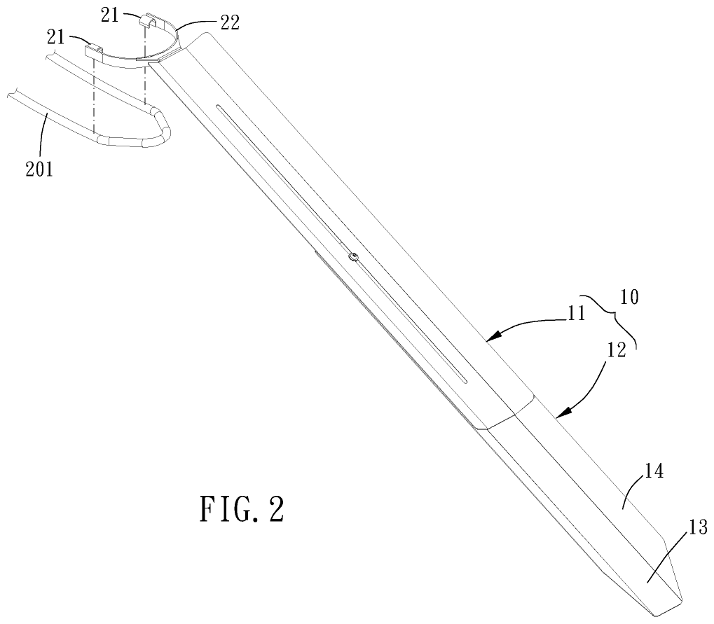

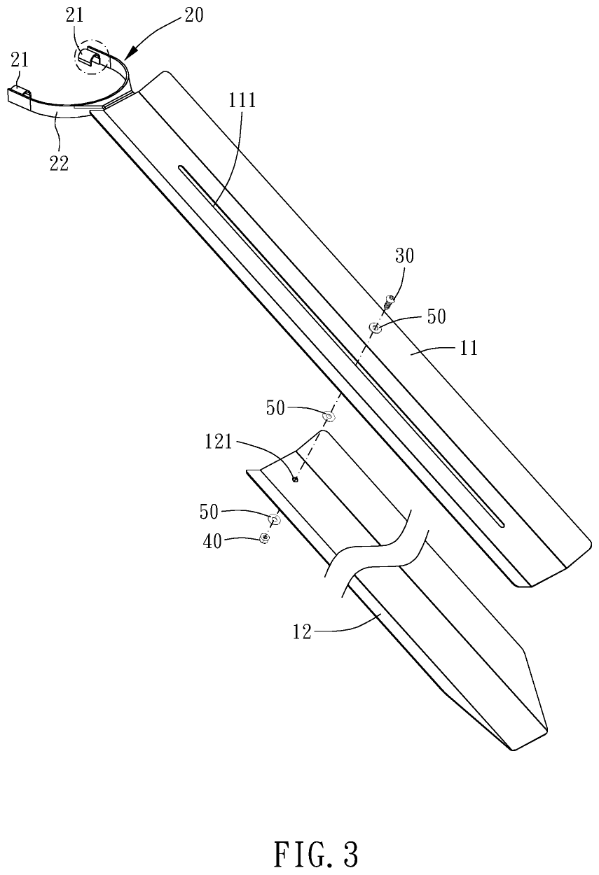

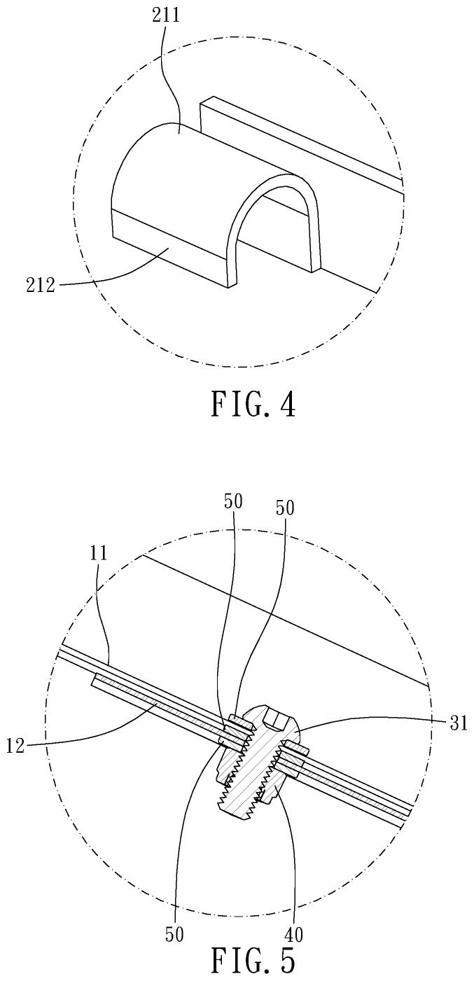

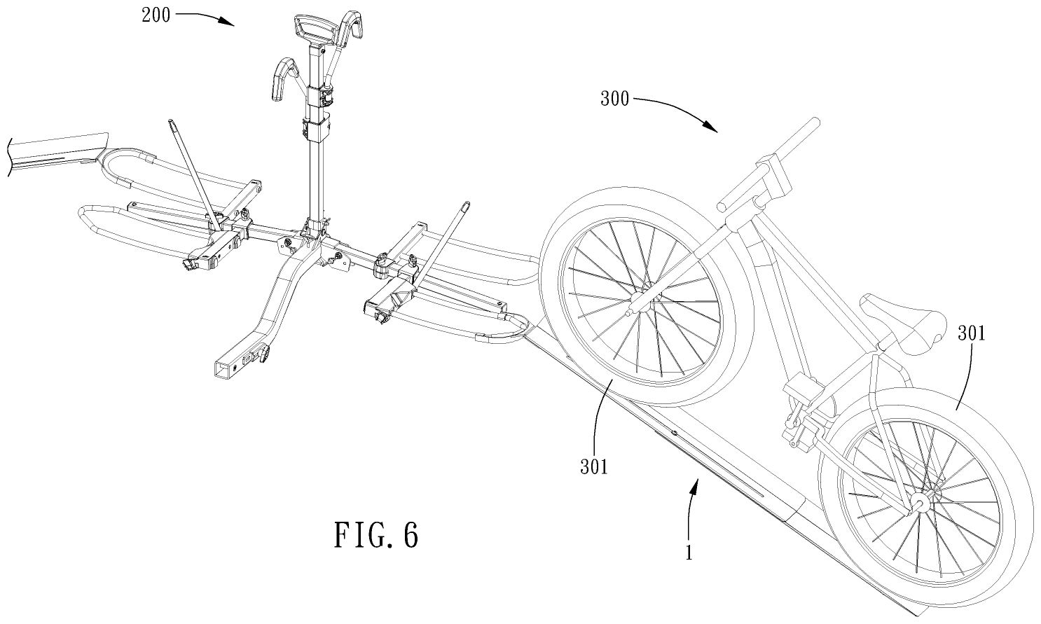

Please refer to FIGS. 1 to 7 for an exemplary embodiment of the present invention. A carrying rack auxiliary device 1 of the present invention is configured to be mounted on at least one wheel restricting ring 201. The invention further provides a carrying rack 200 including the carrying rack auxiliary device 1, a base frame 202 and the at least one wheel restricting ring 201. The base frame 202 is configured to be connected to a vehicle. Preferably, the carrying rack 200 includes a plurality of wheel restricting ring 201, and each two of the plurality of wheel supports 201 are configured to support and restrain front and rear wheels 301 of a vehicle 300.

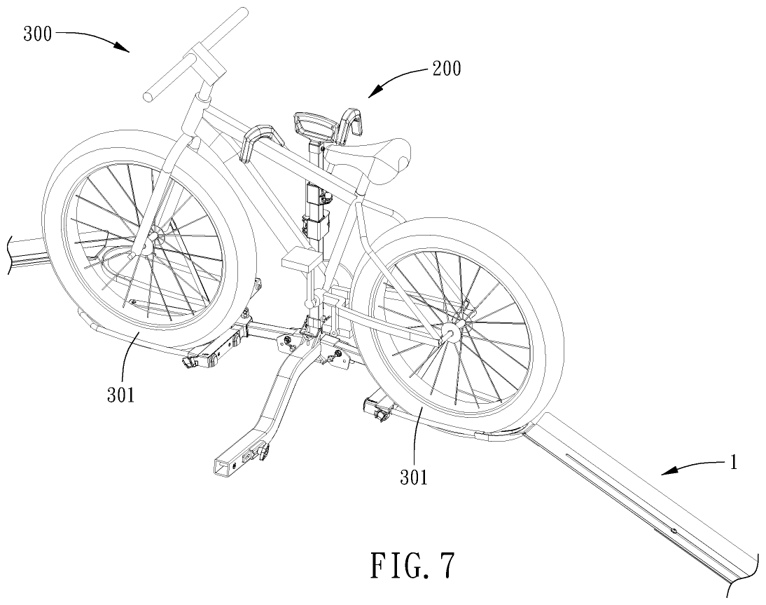

The at least one wheel restricting ring 201 defines a longitudinal central axis L, and the carrying rack auxiliary device 1 includes a guide board 10 and an attachment member 20. The attachment member 20 is connected to an end of the guide board 10, the attachment member 20 includes a plurality of saddle portions 21 separate from each other, the plurality of saddle portions 21 are configured to be saddled on the at least one wheel restricting ring 201 so that the plurality of saddle portions 21 are entirely located out of the longitudinal central axis L and so that the guide board 10 is inclined relative to the longitudinal central axis L. As such, the carrying rack auxiliary device 1 can labor-savingly, quickly and stably guide the vehicle to move along the guide board 10 to the at least one wheel restricting ring 201 (FIGS. 6 and 7).

The guide board 10 includes a first board 11 and a second board 12, and the first board 11 and the second board 12 are retractable relative to each other and adjustably positionable to each other, which can adapt to various operating environments with different heights and distances. Specifically, the first board 11 includes a groove 111, the second board 12 includes a perforation 121, and a bolt 30 is disposed through the groove 111 and the perforation 121 and screwed to a nut 40. After the first board 11 and the second board 12 move relative to each other, the bolt 30 and the nut 40 are relatively turned to tighten the first board 11 and the second board 12, and the length of the guide board 10 is adjusted. Preferably, a plurality of padding members 50 are disposed between a head portion 31 of the bolt 30 and the first board 11, between the first board 11 and the second board 12, and between the second board 12 and the nut 40, and the bolt 30 is disposed through the plurality of padding members 50, thus in addition to improving the fastening stability, it can also reduce the friction and resistance of the relative movement of the first board 11 and the second board 12. Preferably, the guide board 10 further includes a bottom portion 13 and two wings 14 extending and gradually expanding from opposing sides of the bottom portion 13, and each of the two wings 14 remote from the attachment member 20 is tapered, so that it provides good guiding and supporting effect in small size.

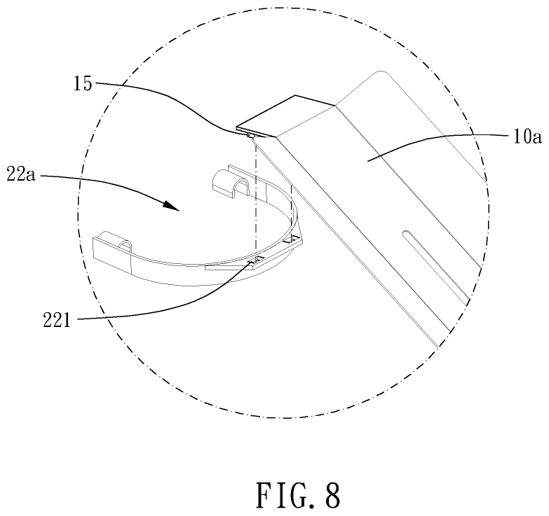

The attachment member 20 further includes a U-shaped body 22 connected to the guide board 10, and the plurality of saddle portions 21 are disposed on two ends of the U-shaped body 22. The U-shaped body 22 or the attachment member 20 is integrally formed with the guide board 10 of one piece, by welding or the like. In this embodiment, the U-shaped body 22 is fixedly connected to the guide board 10; however, the U-shaped body 22a may be detachably connected to the guide board 10a by a connection of a projection 15 and engaging slot 221 (FIG. 8) or other ways. In this embodiment, the plurality of saddle portions 21 are connected to an inner surface of the U-shaped body 22 and correspond to each other. When the plurality of saddle portions 21 are saddled on the at least one wheel restricting ring 201, the plurality of saddle portions 21 are beside opposing sides of the wheel and the U-shaped body 22 is located outside the at least one wheel restricting ring 201, so that the attachment member 20 is free of being pressed by the wheel, and the attachment member 20 is easy to remove and not easy to damage.

Each of the plurality of saddle portions 21 includes a blocking wall 211 and two side walls 212 separately extending from two sides of the blocking wall 211, the blocking wall 211 is configured to be abutted against the wheel restricting ring 201, and the two side walls 212 are configured to be abutted laterally against two sides of the wheel restricting ring 201, so that carrying rack auxiliary device 1 can be stably mounted on the at least one wheel restricting ring 201.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A carrying rack auxiliary device configured to be mounted to at least one wheel restricting ring defining a longitudinal central axis, the carrying rack auxiliary device including:
a guide board; and
an attachment member connected to an end of the guide board and including a plurality of saddle portions separate from each other, the plurality of saddle portions being configured to be saddled on the at least one wheel restricting ring frame so that the plurality of saddle portions are entirely located out of the longitudinal central axis and so that the guide board is inclined relative to the longitudinal central axis.

2. The carrying rack auxiliary device of claim 1, wherein the guide board includes a first board and a second board, and the first board and the second board are retractable relative to each other and positionable to each other.

3. The carrying rack auxiliary device of claim 2, wherein the first board includes a groove, the second board includes a perforation, and a bolt is disposed through the groove and the perforation and connected to a nut.

4. The carrying rack auxiliary device of claim 3, wherein a plurality of padding members are disposed between a head portion of the bolt and the first board, between the first board and the second board, and between the second board and the nut, and the bolt is disposed through the plurality of padding members.

5. The carrying rack auxiliary device of claim 1, wherein the attachment member further includes a U-shaped body connected to the guide board, and the plurality of saddle portions are disposed on two ends of the U-shaped body, respectively.

6. The carrying rack auxiliary device of claim 5, wherein the U-shaped body is fixedly connected to the guide board.

7. The carrying rack auxiliary device of claim 5, wherein the U-shaped body is detachably connected to the guide board.

8. The carrying rack auxiliary device of claim 4, wherein the guide board further includes a bottom portion and two wings extending and gradually expanding from opposing sides of the bottom portion and being; an end of each of the two wings remote from the attachment member is tapered; the attachment member further includes a U-shaped body connected to the guide board, and the plurality of saddle portions are disposed on two ends of the U-shaped body, respectively; the U-shaped body is fixedly connected to the guide board; the plurality of saddle portions are connected to an inner surface of the U-shaped body and correspond to each other.

9. The carrying rack auxiliary device of claim 1, wherein each of the plurality of saddle portions includes a blocking wall and two side walls separately extending from two sides of the blocking wall, the blocking wall is configured to be abutted against the wheel restricting ring, and the two side walls are configured to be abutted laterally against two sides of the wheel restricting ring.

10. A carrying rack including the carrying rack auxiliary device of claim 1 and further including:
a base frame configured to be connected to a vehicle; and
the at least one wheel restricting ring.
